(19) United States
(12) Patent Application Publication
(10) Pub. No.: US 2004/0011933 A1
(43) Pub. Date: Jan. 22, 2004

(54) Vertical compliant tooling

(76) Inventors: Samuel C. Miller, Diamond Bar, CA (US); Michael S. Heuser, Rancho Santa Margarita, CA (US)

Correspondence Address: IRELL & MANELLA LLP, 840 NEWPORT CENTER DRIVE, SUITE 400, NEWPORT BEACH, CA, 92660, US

(21) Appl. No.: 10/200,805

(22) Filed: Jul. 22, 2002

(51) Int. Cl. F16M 11/14

(52) U.S. Cl. 248/183.1

(57) ABSTRACT

A compliant tool that can hold a first electro-optical device while a second device is aligned with the first device. The tool includes a gimbal that allows the first device to rotate about two perpendicular horizontal axes. The tool also has a plurality of brakes that can lock the position of the gimbal when the second device is aligned with the first device. The tool further has an electrical docking station that is connected to the first device after the brakes have locked the position of the gimbal.

### BACKGROUND OF THE INVENTION

1. Field of the Invention

The subject matter disclosed generally relates to the field of tooling for electro-optical devices.

2. Background Information

Electro-optical devices such as laser diodes are typically packaged in a metal container which has a fiber optic pigtail cable attached to the package. The pigtail typically has a ferrule or fiber receptacle that is welded to the laser diode or receiver package. It is highly desirable to maintain parallelism between the metal parts during the attachment of the fiber or fiber receptacle to the laser diode or receiving package.

There have been developed tools that allow a compliant movement of the package during the mating process of the package and the cable. For example, one approach is to provide a tool with a spherical air bearing that allows the package to “float” relative to the ferrule. Once aligned with the ferrule the package is locked into place by pulling a vacuum within the bearing.

Spherical air bearings have a relatively large inertia that results in a slow response time or no response if the parts are too small. Additionally, the package may undergo an undesirable movement during the locking process.

### BRIEF SUMMARY OF THE INVENTION

A tool for aligning a first electro-optical device with a second device. The tool includes a gimbal that allows rotation of the first electro-optical device and a brake that maintains a position of the device.

### BRIEF DESCRIPTION OF THE DRAWINGS

FIG. 1 is a perspective view of a tool for holding an electro-optical device;

FIG. 2 is a cross-sectional view of the tool along a first plane;

FIG. 3 is a cross-sectional view of the tool along a second plane;

FIG. 4 is a bottom view of a gimbal of the tool; and,

FIG. 5 is an enlarged cross-sectional view of a brake of the tool.

### DETAILED DESCRIPTION

Disclosed is a compliant tool that can hold a first electro-optical device while a second device is aligned with the first device. The tool includes a gimbal that allows the first device to rotate about two perpendicular horizontal axes. The tool also has a plurality of brakes that can lock the position of the gimbal when the second device is aligned with the first device. The tool further has an electrical docking station that is actuated and coupled to the first device after the brakes have locked the position of the gimbal.

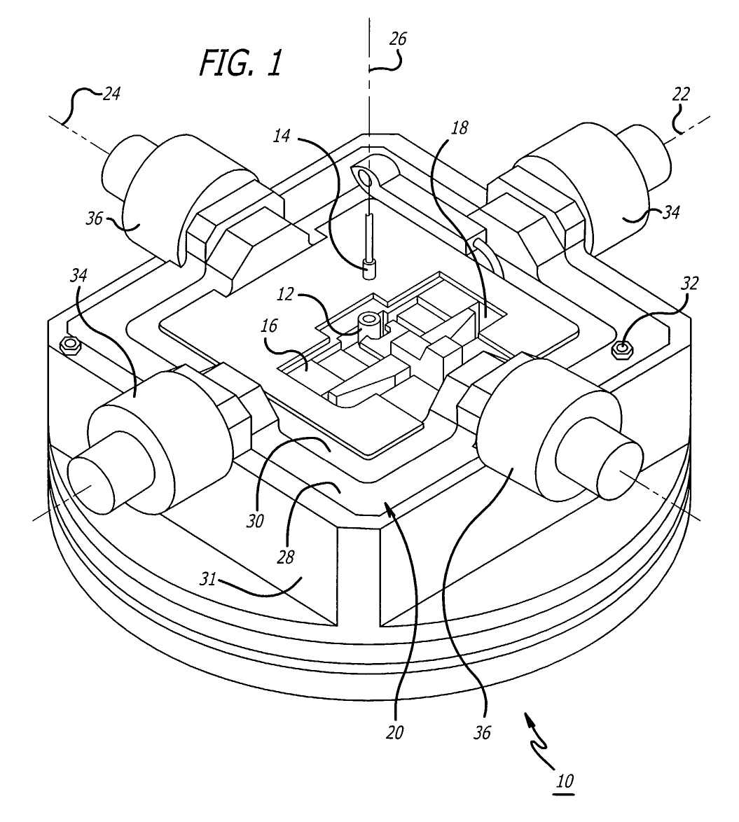

Referring to the drawings more particularly by reference numbers, FIG. 1 shows an embodiment of a tool 10. The tool 10 holds a first electro-optical device 12 that is aligned with a second device 14. By way of example, the first electro-optical device 12 may be a butterfly package that contains a photodiode, laser diode or photodetector. The second device 14 may be a fiber optic cable that is welded to the package. The first device 12 may be mounted to a device carrier 16 that is loaded into a cavity 18 of the tool 10.

The tool 10 includes a gimbal 20 that allows the first device 12 to rotate about a first horizontal axis 22 and a second horizontal axis 24. The horizontal axes 22 and 24 intersect a vertical axis 26 of the devices 12 and 14 at right angles. Rotation of the gimbal 20 allows the second device 14 to properly mate with the first device 12.

The gimbal 20 includes a first ring 28 and a second ring 30 that are pivotally coupled to a base 31. The first ring 28 allows rotation about the first horizontal axis 22. The second ring 30 allows rotation about the second horizontal axis 24. The range of motion of the first ring 30 can be adjusted by turning a screw 32.

The position of the first ring 28 can be locked by a pair of first brakes 34. Likewise, the position of the second ring 30 can be locked by a pair of second brakes 36. The brakes 34 and 36 lock the position of the rings 28 and 30 after the second device 14 has been properly mated with the first device 12.

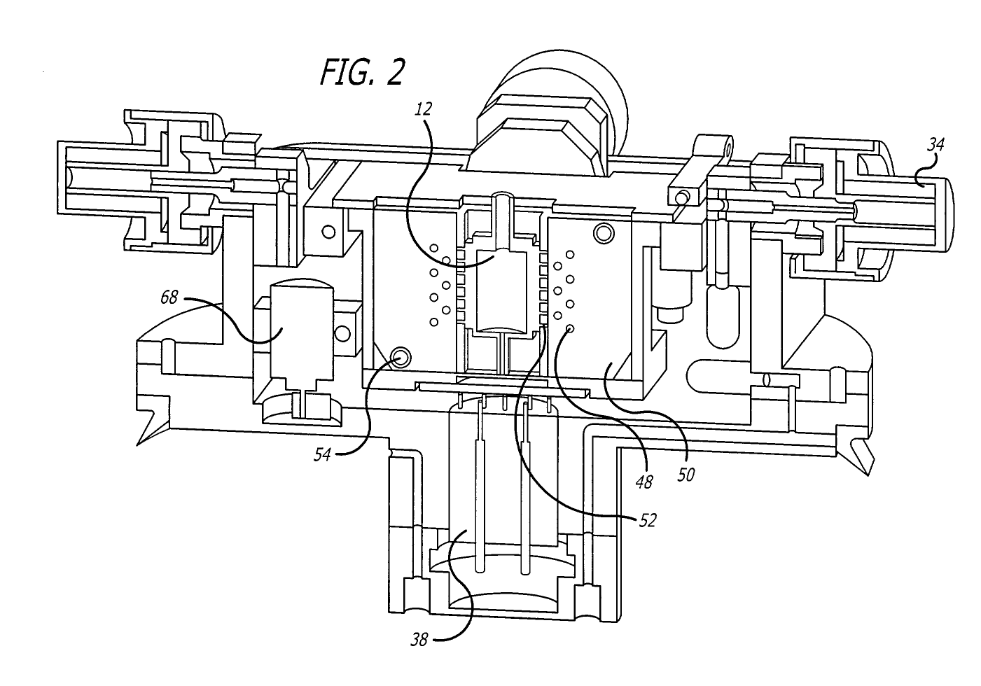

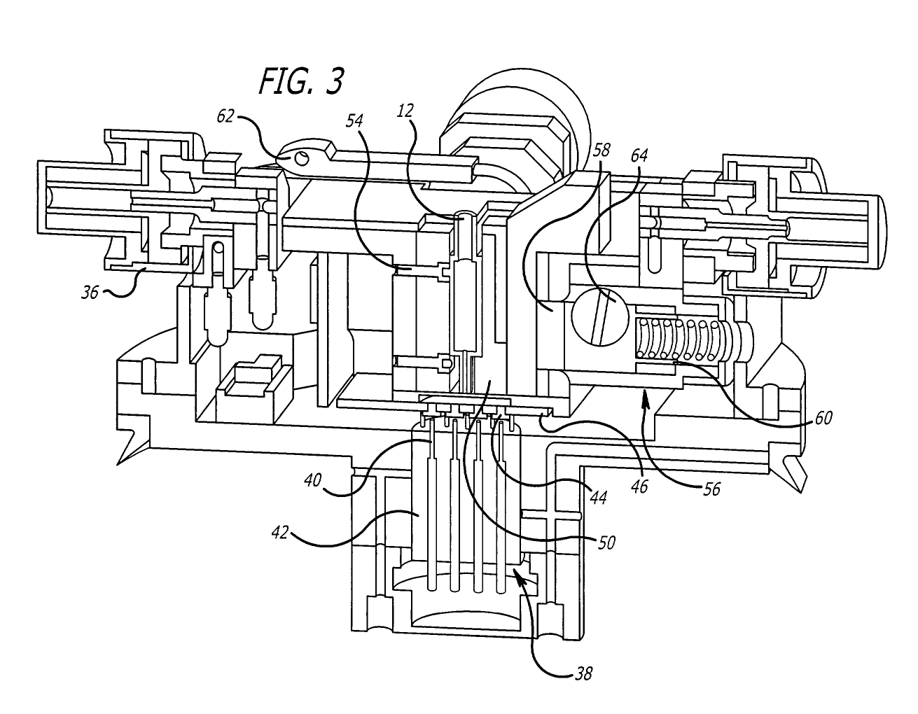

As shown in FIGS. 2 and 3, the tool 10 may include an electrical docking station 38 that can be electrically connected to the first device 12. The docking station 38 may be connected to a power source or other circuit(s) (not shown). It is typically desirable to actuate the first device 12 to determine alignment with the second device 14. For example, if the first device 12 contains a laser diode and the second device 14 is an optical cable, it would be desirable to power the laser diode and sense the optical power transferred through the cable to determine a maximum coupling position.

The electrical docking station 38 includes a plurality of pogo pins 40 attached to a pneumatically driven piston 42. When actuated the piston 42 moves the pins 40 into contact pads 44 of a printed circuit board 46. The printed circuit board 46 is attached to contact pins 48 of a cartridge pad 50 by wires (not shown). The contact pins 44 are in contact with the leads 52 of the first device 12. The tool 10 may have alignment pins 54 that extend into corresponding alignment apertures of the device carrier 16 to align the leads 52 with the contact pins 48.

When the second device 14 is being mated with the first device 12 the docking station 38 is a down position so that the pins 40 do not create drag on the gimbal 20. After the brakes 34 and 36 lock the position of the first device 12 the docking station 38 is moved into an up position so that the pins 40 are in contact with the pads 44 and are electrically connected to the package leads 52.

The tool 10 may have a locking cartridge 56 that pushes the device carrier 16 and first device 12 into the cartridge pad 50. The locking cartridge 56 secures the first device 12 within the tool 10 and presses the contact pins 48 into the leads 52.

The locking cartridge 56 may include a piston 58 that is biased by a spring 60. The piston 58 is coupled to a lever 62 by an eccentric cam 64. The piston 58 can be moved between locked and released positions by moving the lever 62 and rotating the cam 64.

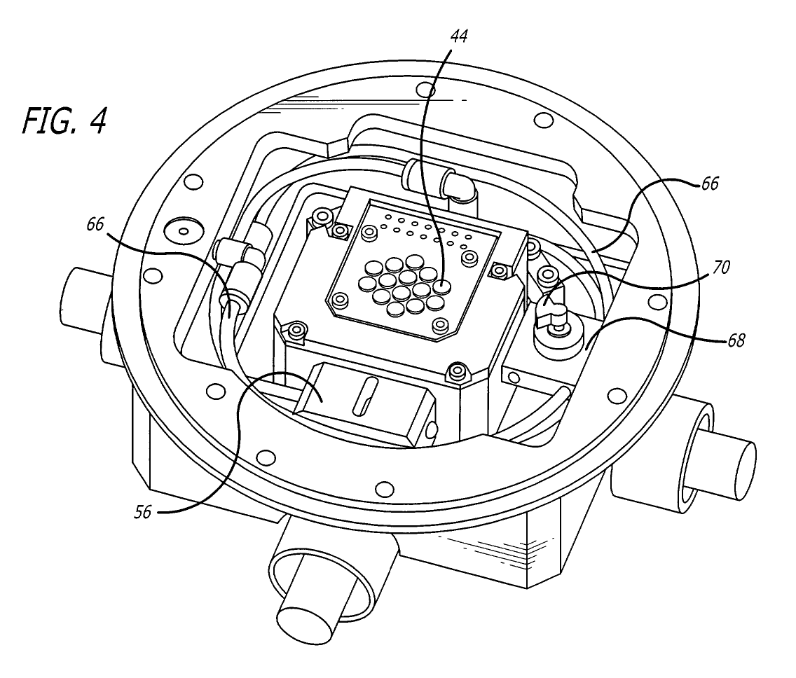

Referring to FIG. 4, each brake 34 and 36 may be connected to a single pneumatic hose 66. Having only one hose 66 reduces the gimbal resistance created by the hoses 66.

The tool 10 may also have a vibrator 68. The vibrator 68 may include an electrically driven eccentric mass 70 that vibrates the first 28 and second 30 rings. The vibration eliminates static forces to reduce the resistance of the rings 28 and 30, and improve the responsiveness of the gimbal 20.

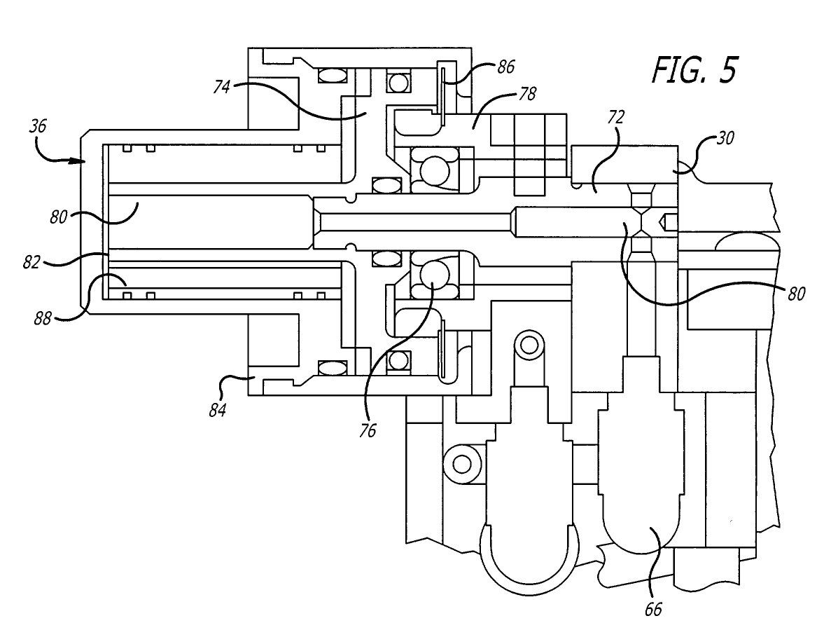

Referring to FIG. 5, each brake 34 or 36 may include an axle 72 that is attached to a ring 28 or 30 and a rotating brake shoe 74. The brake 34 or 36 may include a bearing assembly 76 that allows the axle 72 to rotate relative to a bracket 78 that is attached to the base 31. The brake shoe 74 rotates with the axle 72.

The axle 72 and shoe 74 have air passages 80 that provide fluid communication between a hose 66 and an actuation chamber 82 of a drum 84. The hose 66 can alternatively supply both positive pressure and vacuum pressure. A positive pressure will move the drum 84 leftward and push a flexure ring 86 into the brake shoe 74 to prevent rotation of the shoe 74 and axle 72. This locks the position of the ring 28 or 30 and device 12. A vacuum pressure moves the drum 84 rightward which disengages the flexure 86 from the shoe 74 and allows the ring 28 or 30 to freely rotate. The drum 84 slides along a linear bearing 88. The brakes 34 and 36 allow the rings 28 and 30 to be locked without moving the position of the device 12 during the locking process.

In operation, a first device 12 is loaded into the cavity 18 and the lever 62 is rotated to actuate the locking cartridge 56 and secure the device 12 within the tool 10. The second device 14 is then aligned with the first device 12 by moving device 14 along axis 26 until the two parts are brought together with a residual contact force. The brakes 34 and 36 receive vacuum pressure so that the rings 28 and 30 can freely move and allow the first device 12 to float relative to the second device 14. The residual contact force imparts a rotation moment which causes the gimbal to rotate such that the mating surfaces of parts 12 and 14 are parallel. The vibrator 68 is actuated to reduce the friction of the rings 28 and 30.

Once the second device 14 is mated with the first device 12, positive pressure is provided to the brakes 34 and 36 to lock the rings 28 and 30. The docking station 38 is then actuated to move and create an electrical connection with the device 12.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A tool that holds a first electro-optical device, comprising:
a gimbal that is coupled to the first electro-optical device; and,
a brake coupled to said gimbal.

2. The tool of claim 1, further comprising a vibrator coupled to said gimbal.

3. The tool of claim 1, further comprising a locking cartridge coupled to said gimbal.

4. The tool of claim 1, further comprising an electrical docking station coupled to said gimbal.

5. The tool of claim 4, wherein said electrical docking station includes a plurality of pogo pins.

6. The tool of claim 5, wherein said gimbal includes a printed circuit board that is mated with said pogo pins.

7. The tool of claim 1, wherein said gimbal includes a device carrier alignment pin.

8. The tool of claim 1, wherein said brake includes a rotating brake shoe that is coupled to said gimbal and a linearly moving powered drum coupled to said rotating brake shoe.

9. The tool of claim 1, further comprising a single hose that is coupled to said brake.

10. A tool that holds a first electro-optical device, comprising:
a base;
a first ring that is pivotally coupled to said base;
a second ring that holds the first electro-optical device and is pivotally coupled to said base;
a first brake coupled to said base and said first ring;
a second brake coupled to said base and said second ring; and,
an electrical docking station that is electrically coupled to the first electro-optical device.

11. The tool of claim 10, further comprising a vibrator coupled to said first and second rings.

12. The tool of claim 10, further comprising a locking cartridge coupled to said first and second rings.

13. The tool of claim 10, wherein said electrical docking station includes a plurality of pogo pins.

14. The tool of claim 13, further comprising a printed circuit board that is coupled to said first ring and mated with said pogo pins.

15. The tool of claim 10, further comprising a device carrier alignment pin that is coupled to said first ring.

16. The tool of claim 10, wherein said first and second brakes each include a rotating brake shoe and a linearly moving powered drum coupled to said rotating brake shoe.

17. The tool of claim 11, further comprising a single first hose attached to said first brake and a single second hose attached to said second brake.

18. A method for aligning a first electro-optical device with a second device, comprising:
moving the second device into contact with the first electro-optical device, wherein contact induces a rotation of the first electro-optical device about a first horizontal axis; and,
actuating a brake to lock a position of the first electro-optical device to prevent further rotation about the first horizontal axis.

19. The method of claim 18, further comprising actuating an electrical docking station to couple the electrical docking station with the first electro-optical device.

20. The method of claim 18, further comprising vibrating the first electro-optical device while the second device is moved into contact with the first opto-electrical device.
